(19) United States
(12) Patent Application Publication
(10) Pub. No.: US 2001/0011355 A1
(43) Pub. Date: Aug. 2, 2001

(54) Information terminal with security function

(76) Inventor: Toshimichi Kawai, Yamagata (JP)

Correspondence Address: SUGHRUE, MION, ZINN, MACPEAK & SEAS, 2100 Pennsylvania Avenue, N.W., Washington, DC, 20037, US

(21) Appl. No.: 09/772,940

(22) Filed: Jan. 31, 2001

(30) Foreign Application Priority Data
Feb. 1, 2000 (JP) 2000-024366

(51) Int. Cl. H04L 9/32; G06F 12/14

(52) U.S. Cl. 713/202; 713/183

(57) ABSTRACT

An object of the present invention is to provide an information terminal having a security function in which confidentiality and safety by which only a user who has stored a password can use can be retained, and the information apparatus can be used with out inputting the password every time when the power supply is turned on. The user is identified by using the communication between an information apparatus and a battery pack to read out passwords, and a communication section controls to turn on a second switch when the passwords correspond so that power is supplied to a device load.

### BACKGROUND OF THE INVENTION

1. Technical Field of the Invention

The present invention relates to an information terminal having a security function and more particularly to an information terminal having a security function exclusively used by a user who has stored a password, thereby secures confidentiality and safety of information.

2. Description of the Prior Art

In general, in this kind of information terminal, information is secured by inputting a password at an initial time, when using the information terminal.

For example, in JP 10-91265 A (1998), a user of a portable information apparatus inputs a password so as to strengthen the security protection.

FIG. 3 is a constitutional block diagram of a portable information apparatus described in JP 10-91265 (1998).

Referring to FIG. 3, in a conventional portable type information apparatus 50, when the power supply of the portable type information apparatus 50 is turned on, and when a displayed information presented by an information presentation section 53 is switched into other displayed information by an input section 51, a security confirmation section 57 requests the user to input a password. When the user inputs a password in response to the requirement of the security confirmation section 57, a wrong use prevention section 58 determines whether or not the inputted password is identical with the password that is set in advance and has been stored in a password memory 56. When the inputted password is not identical with the stored password, the power supply of the portable type information apparatus 50 is turned off, and information indicating wrong use is stored in an information memory 54.

Further, in JP 10-149337 (1998), the security is improved by restricting the digits of password. Concretely, a small size information apparatus is put into a start halt mode when the password digit exceeds a fixed number. The start disable state is released by an input signal which is peculiar to the small size information apparatus registered previously and which is through a hardware medium different from the small size information apparatus.

However, the conventional technique as disclosed in JP 10-91265 A (1998) has a disadvantage that, even if a user is not the user who has stored the password, when he merely inputs the same password stored in the information apparatus, the use of the information apparatus becomes possible. For example, it is possible to know the password by performing analysis of the program by which security management is performed, using a debug tool or the like. Further, the conventional technique as disclosed in JP 10-149337 (1998) has a disadvantage that when the information apparatus is used, a user has to input the same password as the password registered in advance in the information apparatus at every starting time, whereby the operation is troublesome.

### SUMMARY OF THE INVENTION

It is an object of the present invention to read out the password by using a communication between a battery pack and an information apparatus. The information apparatus can be used, exclusively by the user who holds the password, without inputting the password every time when the password holder want to use the information terminal.

The information terminal having a security function of the present invention is an information terminal having a security function comprising an information apparatus and a battery pack being connected to the information apparatus and supplying power thereto, the terminal characterized in that the information apparatus comprises a device load having an input device, a first switch turning on/off the power supply supplied from the battery pack, an apparatus memory storing a first password, a communication section communicating with the apparatus memory, the input device, and the battery pack, and a second switch in which the power supply from the battery pack to the device load is on/off controlled by the communication section, and that the battery pack comprises a battery and a battery memory storing a second password read by communication with the communication section.

The information terminal having a security function of the present invention may be an information terminal having a security function comprising an information apparatus and a battery pack being connected to the information apparatus and supplying power thereto, the terminal characterized in that the information apparatus comprises a device load having an input device, a first switch turning on/off the power supply supplied from the battery pack, an apparatus memory storing a first password, a communication section communicating with the apparatus memory, the input device, and the battery pack, and a second switch in which a load power supply supplying power to the device load is on/off controlled by the communication section, and that the battery pack comprises a battery and a battery memory storing a second password read by communication with the communication section.

The communication section is characterized by communicating with the battery memory and the apparatus memory when the first switch is turned on, reading the second password stored in the battery memory, and reading the first password stored in the apparatus memory to compare the first password with the second password.

The communication section is characterized by turning on the second switch to supply power from the battery pack to the device load when the first password corresponds to the second password as a result of the comparison therebetween and turning off the second switch not to supply power from the battery pack to the device load when the first password differs from the second password.

The communication section is characterized by turning on the second switch to supply power from the load power supply to the device load when the first password corresponds to the second password as a result of the comparison therebetween and turning off the second switch not to supply power from the load power supply to the device load when the first password differs from the second password.

The battery is characterized by supplying power to the device load, the apparatus memory, the communication section, and the battery memory.

The battery is characterized by supplying power to the apparatus memory, the communication section, and the battery memory.

The battery memory is characterized by being supplied power from the information apparatus.

The input device is characterized by performing setting or setting change of the first password and the second password via the communication section.

The first password and the second password are characterized by being the same.

Setting of the first password and the second password is characterized by being performed prior to factory shipment.

The first password and the second password are characterized by being any one of a number, a letter, and a cipher.

Both the apparatus memory and the battery memory are characterized by having a non-volatile memory.

The non-volatile memory is characterized by being an electrically erasable and programmable read only memory (EEPROM).

As explained above, in the information terminal having the security function of the present invention, since a user is determined by the communication between the communication section and the apparatus memory of the information apparatus and the battery memory to read and compare the first password of the apparatus memory and the second password of the battery memory, there is advantageous effect that there is no opportunity of inputting a password for a person other than the user who has stored the password, and only the user who has stored the password in advance can use the information apparatus.

Since a user is determined by the communication with the battery memory of the battery pack and power is supplied to the device load by the control of the communication section, there is an advantageous effect that the operation that a password is inputted every time the power supply of the information apparatus is turned on to start the information apparatus is eliminated once a password is set, and a user is released from the complexity of inputting a password.

Further, since power is supplied from the load power supply distinct from the battery of the battery pack to the device load, there is an advantageous effect that the battery pack can be miniaturized, and the use of an information apparatus needing a high power that cannot be driven by the battery pack becomes possible.

### BRIEF EXPLANATION OF THE DRAWINGS

FIG. 1 is a constitutional block diagram showing a first embodiment of an information terminal having a security function of the present invention.

FIG. 2 is a constitutional block diagram showing a second embodiment of an information terminal having a security function of the present invention.

FIG. 3 is a constitutional block diagram of a conventional portable type information apparatus.

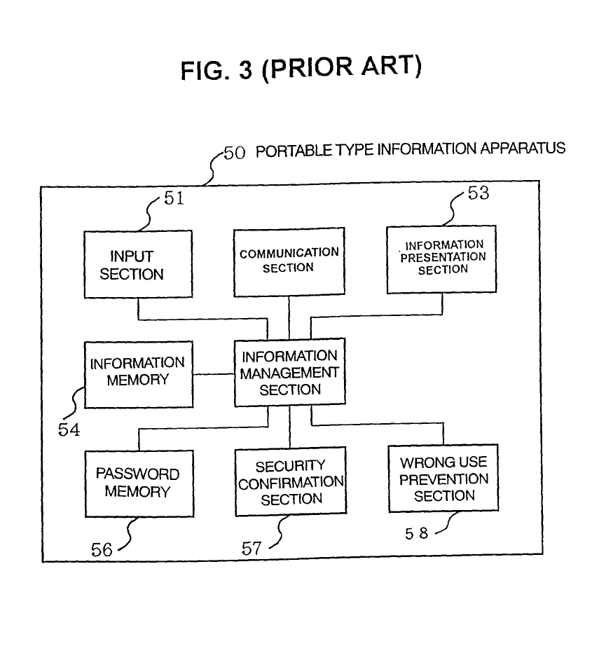

### PREFERRED EMBODIMENT OF THE INVENTION

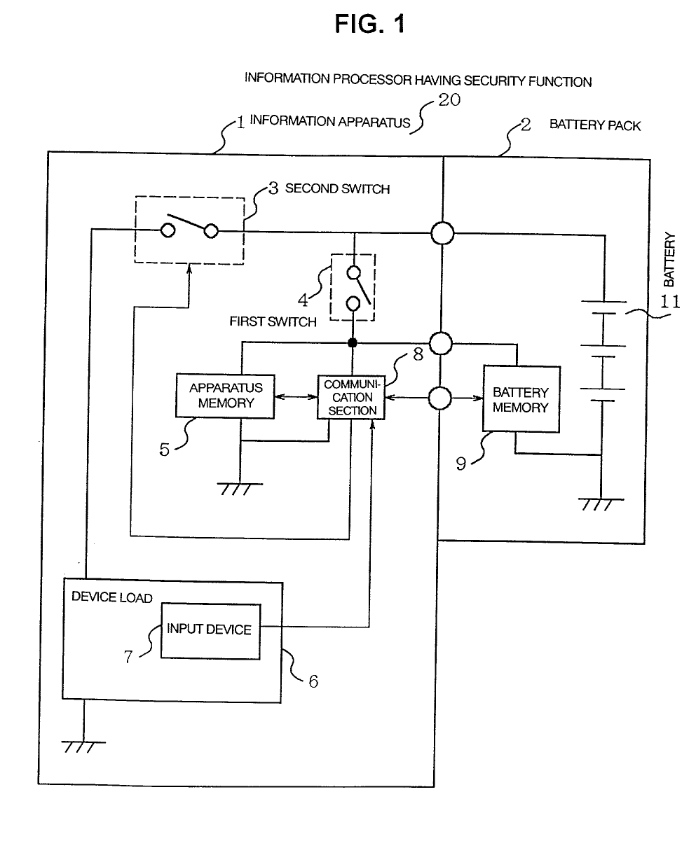

FIG. 1 is a constitutional block diagram showing a first embodiment of an information terminal having a security function of the present invention.

Referring to FIG. 1, an information terminal 20 having a security function is composed of an information apparatus 1 and a battery pack 2 connected to the information apparatus 1. The information apparatus 1 has a device load 6 having an input device 7, a first switch 4 turning on/off the power supply supplied from a battery 11 of the battery pack 2, an apparatus memory 5 composed of an EEPROM (Electrically Erasable Programmable Read Only Memory) of a non-volatile memory storing a first password, a communication section 8 communicating with the apparatus memory 5, the input device 7, and a battery memory 9 of the battery pack 2, and a second switch 3 in which power supply from the battery pack 2 to the device load 6 is on/off controlled by the communication section 8. The battery pack 2 is composed of the battery 11 and the battery memory 9 composed of an EEPROM of a non-volatile memory storing a second password read by the communication with the communication section 8. The battery 11 supplies power to the apparatus memory 5, the battery memory 9, the communication section 8, and the device load 6.

The first password may be inputted by the input device 7 through the communication section 8 and apparatus memory 5, while the second password may be inputted by the input device 7 through the communication section 8 and battery memory 9. The first and the second password may be inputted prior to factory shipment. Further, the first password is identical with the second password.

Next, operations of the information terminal 20 having the security function constituted as described above is explained, referring to drawings.

When a user using the information terminal 20 having the security function turns on the first switch 4, the communication section 8 communicates with the apparatus memory 5 and the battery memory 9 to read the second password stored in the battery memory 9 and read the first password stored in the apparatus memory 5 to compare the first password with the second password.

Here, the following is explained, supposing that, as one example, the password is a four-digit number and is “1234.” The password may be any one of codes enciphered, employing letters, numbers, and an encipherment technique, and needless to say, there is no special restriction in the number of digits or kinds.

Since the result of the comparison of “1234” of the first password and “1234” of the second password is of correspondence with each other, the communication section 8 turns on the second switch so that the power from the battery 11 of the battery pack 2 is supplied to the device load 6, whereby the information apparatus 1 becomes usable.

In the apparatus memory 5 and the battery memory 9, the non-volatile EEPROMs are employed so that the apparatus memory 5 and the battery memory 9 can store the first password and the second password even when the power is not supplied.

Next, explained is the case in which a wrong user who is not the owner of the information terminal 20 having the security function connects the same type battery pack 2 in order to wrongly use this information apparatus 1.

It is supposed that in the battery memory 9 of the battery pack 2 that the wrong user owns, for example, “2345” is stored as the second password.

When the wrong user turns on the switch 4 in order to use the information apparatus 1, the communication section 8 communicates with the apparatus memory 5 and the battery memory 9 to read “1234” of the first password stored in the apparatus memory 5 and “2345” of the second password to compare the respective passwords. Since in the result of the comparison, the respective passwords do not correspond, the communication section 8 controls so that the second switch 3 is not turned on, whereby the power from the battery 11 of the battery pack 2 is not supplied to the device load 6, and thus the use of the information apparatus 1 by the wrong user becomes unusable.

Next, setting change in the first password and the second password is explained.

In the state in which the information terminal 20 having the security function is usable, that is, in the state in which the information apparatus 1 and the battery pack 2 are combined, if the first password and the second password are the same and state is that the power is supplied to the device load 6, the user can change the password.

Now, it is supposed that the password is changed to be “5678”.

When the user inputs the password “5678” of that after the setting change through the input device 7, the communication section 8 communicates between the apparatus memory 5 and the battery memory 9, and setting change is done by changing both the first password and the second password from “1234” to “5678.”

Accordingly, in a state of the time of purchasing the information terminal 20 having the security function composed of the information apparatus 1 and the battery pack 2, that is, in the case where the first password and the second password are the same, the user can change the passwords to arbitrary passwords, and it is completely impossible that a wrong user uses an arbitrary combination of an information apparatus 1 and a battery pack 2 whose purchase times are different.

As described above, the user is determined by the communication between the communication section 8 and the apparatus memory 5 of the information apparatus 1 and the battery memory 9 of the battery pack 2 employed as power supply while utilizing passwords. Therefore, there is no opportunity of inputting a password for a person other than the user who has stored the password, and only the user who has stored the password in advance in the information terminal 20 having the security function can use the information apparatus 1.

Further, the user is determined by the communication with the battery pack 2 to turn on the power supply of the device load 6 of the information apparatus 1. Therefore, it is not required to input the password every time when the power supply of the information apparatus 1 is turned on to start the information apparatus 1. Accordingly, the user saves the trouble of inputting the password.

Next, a second embodiment of the information terminal having a security function of the present invention will be explained, referring to drawings.

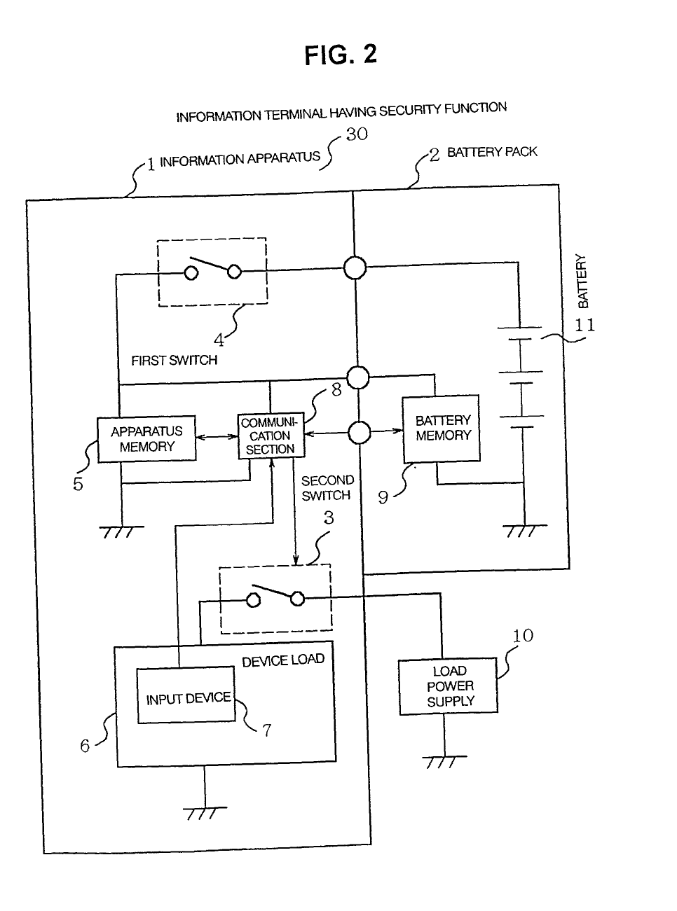

FIG. 2 is a constitutional block diagram showing the second embodiment of an information terminal having a security function of the present invention.

The same components as those in the first embodiment shown in FIG. 1 are represented by the same reference numerals.

Referring to FIG. 2, an information terminal 30 having a security function is composed of an information apparatus 1 and a battery pack 2 connected to the information apparatus 1 and supplying power thereto. The information apparatus 1 has a device load 6 having an input device 7, a first switch 4 turning on/off the power supply supplied from a battery 11 of the battery pack 2, an apparatus memory 5 composed of an EEPROM of a non-volatile memory storing a first password, a communication section 8 communicating with the apparatus memory 5, the input device 7, and a battery memory 9 of the battery pack 2, and a second switch 3 in which a load power supply 10 supplying power to the device load 6 is on/off controlled by the communication section 8. The battery pack 2 is composed of the battery 11 and the battery memory 9 composed of an EEPROM of a non-volatile memory storing a second password read by the communication with the communication section 8. The battery 11 supplies power to the apparatus memory 5, the battery memory 9, and the communication section 8. The battery memory 9 is structured so as to be supplied power from the information apparatus 1.

The point that the information terminal 30 differs from the information terminal 20 of the first embodiment is that the device load 6 including the input device 7 is connected to the load power supply 10, that the device load 6 receives the power supply from the load power supply 10, and that the battery 11 of the battery pack 2 supplies power to the apparatus memory 5, the communication section 8, and the battery memory 9 and does not supply power to the device load 6. In addition to the advantageous effect of the information terminal 20 having the security function of the first embodiment, the terminal 30 has an advantageous effect that the battery pack 2 can be miniaturized, and power can be supplied even to an information apparatus 1 needing a high power that cannot be driven by the battery pack 2 to enable the device 1 to be driven.

Since the operations of the information terminal 30 having the security function are the same as those of the information terminal 20 having the security function of the first embodiment described above except for the point described above, the explanation thereof is omitted.

What is claimed is:

1. An information terminal including an information apparatus and a battery pack, wherein:
said information apparatus comprises:
a device load having an input device;
a first switch for switching on/off the electric power supplied by said battery pack;
an apparatus memory for storing a first password;
a communication section for communicating with said apparatus memory, said input device and said battery pack; and
a second switch for switching on/off the electric power for said device load supplied by said battery pack, on the basis of a control signal from said communication section, and
said battery pack comprises:
a battery for supplying electric power for said information apparatus; and
a battery memory for storing a second password,
wherein said communication section communicates with said battery memory and said apparatus memory, when said first switch is turned on, reads out said first and second to compare said first password with said second password, and
said communication section turns on said second switch so as to supply electric power from the battery pack to said device load when said first password is identical to said second password as a result of the comparison, while it turns off said second switch so as not to supply electric power from said battery pack to the device load when said first password differs from said second password.

2. An information terminal including an information apparatus and a battery pack, wherein:
said information apparatus comprises:
a device load having an input device;
a first switch for switching on/off the electric power supplied by said battery pack;
an apparatus memory for storing a first password;
a communication section for communicating with said apparatus memory, said input device and said battery pack;
a load power supply for supplying electric power for said device load; and
a second switch for switching on/off the electric power for said device load supplied by said load power supply, on the basis of a control signal from said communication section, and said battery pack comprises:
a battery for supplying electric power for said information apparatus; and
a battery memory for storing a second password,
wherein said communication section communicates with said battery memory and said apparatus memory, when said first switch is turned on, reads out said first and second to compare said first password with said second password, and
said communication section turns on said second switch so as to supply electric power from the battery pack to said device load when said first password is identical to said second password as a result of the comparison, while it turns off said second switch so as not to supply electric power from said load power supply to the device load when said first password differs from said second password.

3. The information terminal according to claim 1, wherein said battery supplies electric power to said device load, said apparatus memory, said communication section and said battery memory.

4. The information terminal according to claim 2, wherein said battery supplies power to said apparatus memory, said communication section and said battery memory.

5. The information terminal according to claim 1, wherein power is supplied from said information apparatus to said battery memory.

6. The information terminal according to claim 1, wherein said input device performs setting or changing said first and/or second passwords via said communication section.

7. The information terminal according to claim 2, wherein said input device performs setting or changing said first and/or second passwords via said communication section.

8. The information terminal according to claim 7, wherein said first password is identical with said second password.

9. The information terminal according to claim 7, wherein said first password and said second password are set up prior to a factory shipment.

10. The information terminal according to claim 7, wherein said first password and said second password are any one of a number, a letter, and a cipher.

11. The information terminal according to claim 1, wherein both said apparatus memory and said battery memory are non-volatile.

12. The information terminal according to claim 11, wherein each of said memories is an EEPROM.
